(19) United States
(12) Patent Application Publication
(10) Pub. No.: US 2026/0313570 A1
(43) Pub. Date: Oct. 8, 2026

(54) Supporting Dedicated Spectrum Less Than 5mhz In Wireless Communication

(71) Applicant: Apple Inc., Cupertino, CA (US)

(72) Inventors: Hong HE, San Jose, CA (US); Ankit BHAMRI, Haar (DE); Chunxuan YE, San Diego, CA (US); Dan WU, Beijing (CN); Dawei ZHANG, Saratoga, CA (US); Wei ZENG, Saratoga, CA (US)

(21) Appl. No.: 19/482,073

(22) PCT Filed: May 9, 2023
(86) PCT No.: PCT/CN2023/093050

§ 371 Date: Nov. 6, 2025

(51) Int. Cl. H04W 56/00; H04L 1/00; H04L 27/26; H04W 48/08; H04W 72/231

(52) U.S. Cl. CPC H04W 56/0015; H04L 1/0068; H04L 27/26025; H04W 48/08; H04W 72/231

(57) ABSTRACT

A user equipment (UE) configured for operations with a serving cell in spectrum allocations less than 5 MHz. The UE configured to detect a synchronization signal block (SSB) including a primary synchronization signal (PSS) spanning a number of subcarriers, a secondary synchronization signal (SSS) spanning the number of subcarriers, and a physical broadcast channel (PBCH) that is considered to comprise a same number of subcarriers as the PSS and SSS, decode the PBCH and determine, from the PBCH, a configuration, a location and a bandwidth in a frequency domain for a control resource set 0 (CORESET #0) defining resources associated with a common search space (CSS) for a physical downlink control channel (PDCCH) monitoring.

### TECHNICAL FIELD

The present disclosure generally relates to wireless communication, and in particular, to supporting dedicated spectrum less than 5 MHz in wireless communication.

### BACKGROUND INFORMATION

A synchronization signal block (SSB) broadcast by a network cell comprises synchronization signals (SS) (a primary synchronization signal (PSS) and a secondary synchronization signal (SSS)) and a physical broadcast channel (PBCH). The PBCH carries parameters indicating the location and time/frequency resources on the resource grid for a ControlResourceSet0 (CORESET #0), which carries the downlink control information (DCI) used to decode system information block 1 (SIB1). The system information extracted from SIB1 allows the UE to initiate the random access (RACH) procedure and establish a dedicated connection with the cell.

It is a 5G New Radio (NR) objective to identify and specify necessary changes to the NR physical layer for channel bandwidths (CBW) less then 5 MHz, including a 3 MHz CBW. The 3 MHz CBW may be restricted to a subcarrier spacing (SCS) of 15 kHz, corresponding to 15 physical resource blocks (PRB) in the frequency domain for a 3 MHz CBW. However, 15 kHz SCS operation typically relies on a minimum 4.32 MHz CBW corresponding to 24 PRBs in the frequency domain. In one example, the SSB structure according to current specification spans 20 PRBs (240 subcarriers) in the frequency domain. Thus, for CBWs less than 5 MHz, the available PRBs for PBCH transmission is less than 20 PRBs. Further specification is necessary for the NR physical layer for operations in spectrum allocations under 5 MHz, particularly with regard to the SSB design and other initial access processes.

### SUMMARY

Some exemplary embodiments are related to a processor of a user equipment (UE) configured for operations with a serving cell in spectrum allocations less than 5 MHz. The processor is configured to detect a synchronization signal block (SSB) including a primary synchronization signal (PSS) spanning a number of subcarriers, a secondary synchronization signal (SSS) spanning the number of subcarriers, and a physical broadcast channel (PBCH) that is considered to comprise a same number of subcarriers as the PSS and SSS, decode the PBCH and determine, from the PBCH, a configuration, a location and a bandwidth in a frequency domain for a control resource set 0 (CORESET #0) defining resources associated with a common search space (CSS) for a physical downlink control channel (PDCCH) monitoring.

Other exemplary embodiments are related to a processor of a user equipment (UE) configured for operations with a serving cell in spectrum allocations less than 5 MHz. The processor is configured to detect a synchronization signal block (SSB) including a primary synchronization signal (PSS), a secondary synchronization signal (SSS), and a physical broadcast channel (PBCH), decode the PBCH, determine a number of resource blocks (RB) in a resource element group (REG) bundle for a CORESET #0 that is predefined for the spectrum allocations less than 5 MHz, determine a number of control channel elements (CCEs) and whether a punctured CCE (pCCE) is present in the CORESET #0 and determine a number of physical downlink control channel (PDCCH) candidates to monitor in a common search space associated with the CORESET #0 based on whether a PDCCH candidate comprising the pCCE is to be monitored.

Still further exemplary embodiments are related to a processor of a base station configured for operations with a first user equipment (UE) in spectrum allocations less than 5 MHz. The processor is configured to transmit a synchronization signal block (SSB) including a primary synchronization signal (PSS), a secondary synchronization signal (SSS), and a physical broadcast channel (PBCH), wherein the PBCH comprises a same number of subcarriers as the PSS and SSS, wherein the PBCH indicates a configuration, a location and a bandwidth in a frequency domain for a control resource set 0 (CORESET #0) defining resources associated with a common search space (CSS) for monitoring a physical downlink control channel (PDCCH) and transmit one PDCCH within one or more PDCCH candidates in the CORESET #0, wherein the one or more PDCCH candidates are determined based on whether a punctured control channel element (pCCE) is to be monitored by the first UE.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary network cell according to various exemplary embodiments.

FIG. 4 shows a structure of a SSB according to current specification.

FIG. 5a shows a table for the structure of an SSB including an entry for CBWs less than 5 MHz according to various exemplary embodiments.

FIG. 5b shows a diagram of the exemplary punctured PBCH transmission for a SSB according to CBW Case-2 and a CORESET #0 offset determined from the PBCH according to various exemplary embodiments.

FIG. 5c shows a table for possible TBWs for a CBW of 3 MHz (CBW Case-2) according to various exemplary embodiments.

FIG. 5d shows a diagram for the bandwidth of CORESET #0 in view of different TBWs according to various exemplary embodiments.

FIG. 6a shows a diagram for CCE-to-REG mapping when a punctured CCE (pCCE) is not used for PDCCH transmission according to various examples of these exemplary embodiments.

FIG. 6b shows a table referring to the diagram of FIG. 6a and summarizing the total number of PDCCH candidates and the number of CCEs in candidate K_1 per aggregation level (AL).

FIG. 7a shows a diagram for CCE-to-REG mapping when a punctured CCE (pCCE) is used for PDCCH transmission according to various examples of these exemplary embodiments.

FIG. 7b shows a table referring to the diagram of FIG. 7a and summarizing the total number of PDCCH candidates and the number of CCEs in candidate K_1 per aggregation level (AL).

FIG. 8 shows a diagram including the PDCCH candidate(s) without counting the pREG-Bundle #7 (i.e., Rel-17 mapping) and an enhanced interleaved PDCCH search space set according to various exemplary embodiments.

FIG. 9a shows a table for indicating the configuration of CORESET #0 for CBW under 5 MHz by repurposing an existing field according to various exemplary embodiments.

FIG. 9b shows a new table for indicating the configuration of CORESET #0 for CBW less than or equal to 5 MHz according to various exemplary embodiments.

FIG. 10 shows a method for initial access for spectrum less than 5 MHz according to various exemplary embodiments.

### DETAILED DESCRIPTION

The exemplary embodiments may be further understood with reference to the following description and the related appended drawings, wherein like elements are provided with the same reference numerals. The exemplary embodiments describe systems and methods for 5G New Radio (NR) operations with dedicated spectrum less than 5 MHz. It is a 5G New Radio (NR) objective to identify and specify necessary changes to the NR physical layer for channel bandwidths (CBW) less then 5 MHz, including a 3 MHz CBW. Various aspects of initial access procedures are impacted when operating with this narrow bandwidth. The exemplary embodiments relate to mechanisms for operating in the less than 5 MHz spectrum, including: synchronization signal block (SSB) broadcast and reception (particularly with regard to the physical broadcast channel (PBCH); indicating and/or determining parameters for a control resource set 0 (CORESET #0); and control channel element (CCE) to resource element group (REG) mapping for the CORESET #0. Further, mechanisms are described for preventing legacy user equipment (UE) from accessing a serving cell operating with less than 5 MHz spectrum.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

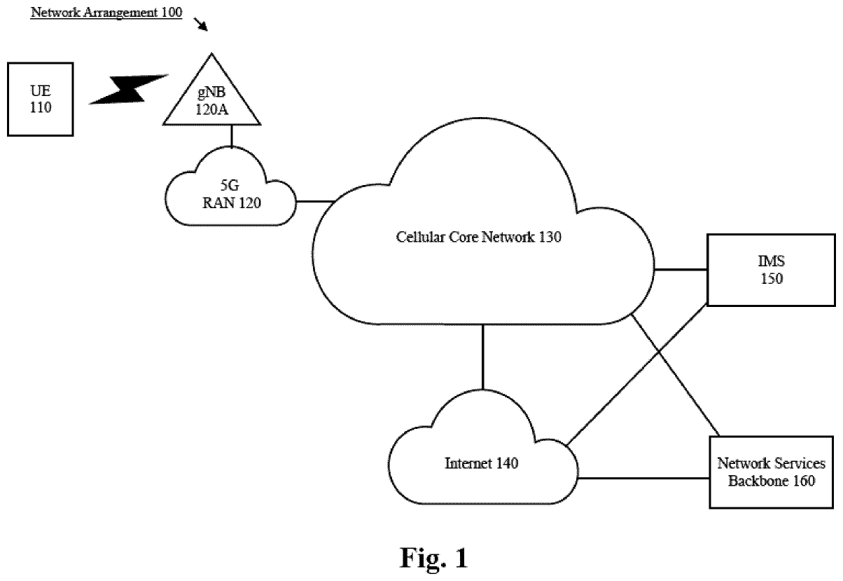

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

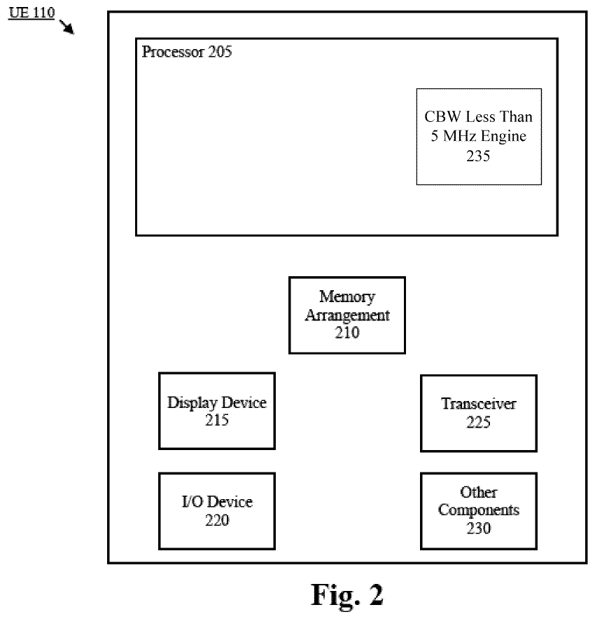

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include CBW less than 5 MHz engine 235. The CBW less than 5 MHz engine 235 may perform various operations related to system information (SI) reception when operating with spectrum allocations less than 5 MHz.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

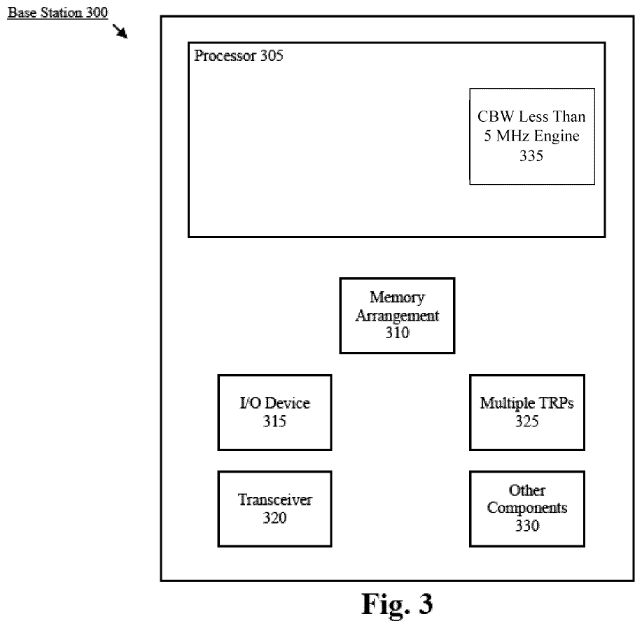

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 325 may be deployed locally at the base station 300. In other scenarios, one or more of the multiple TRPs 325 may be deployed at physical locations remote from the base station 300 and connected to the base station via a backhaul connection. The base station 300 may be configured to control the multiple TRPs 325 and perform operations such as, but not limited to, assigning resources, configuring reference signals, implementing beam management techniques, etc.

The processor 305 may be configured to execute a plurality of engines for the base station 300. For example, the engines may include CBW less than 5 MHz engine 335. The CBW less than 5 MHz engine 235 may perform various operations related to system information (SI) transmission when operating with spectrum allocations less than 5 MHz.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

There are objectives in 5G NR for specifying support for dedicated spectrum less than 5 MHz (narrowband) for FR1. These objectives include identifying and specifying necessary changes to the NR physical layer to operate in these narrowband spectrum allocations with minimum specification impact. It was agreed to support a 5 MHz channel bandwidth (CBW) and a 3 MHz channel bandwidth (CBW). The 5 MHz CBW may be referred to herein as CBW Case-1 and the 3 MHz CBW may be referred to herein as CBW Case-2.

A synchronization signal block (SSB) broadcast by a network cell comprises synchronization signals (SS) (a primary synchronization signal (PSS) and a secondary synchronization signal (SSS)) and a physical broadcast channel (PBCH). The PBCH carries parameters indicating the location and resources on the resource grid for a ControlResourceSet0 (CORESET #0), which carries the downlink control information (DCI) used to decode system information block 1 (SIB1). The system information extracted from SIB1 allows the UE to initiate the random access (RACH) procedure and establish a dedicated connection with the cell.

The SSB structure according to current specification spans four orthogonal frequency division multiplexing (OFDM) symbols in the time domain and 20 physical resource blocks (PRBs) (240 subcarriers) in the frequency domain. The PBCH is spread across multiple symbols.

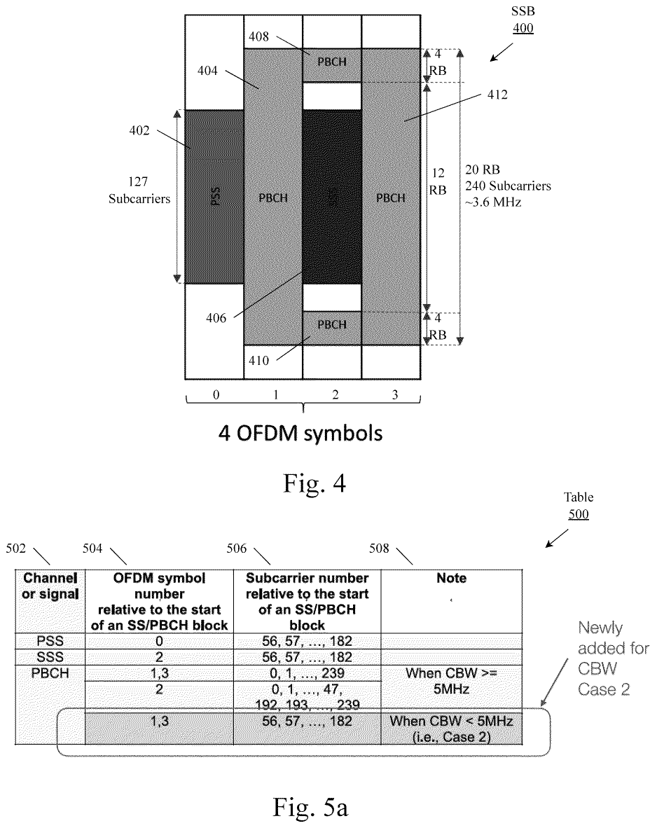

FIG. 4 shows a structure of a SSB 400 according to current specification. The SSB 400 spans four OFDM symbols (0-3) in the time domain and 20 PRBs in the frequency domain. In the first symbol (symbol 0) is the PSS 402 spanning 127 subcarriers in the frequency domain. The PBCH is spread across the second, third and fourth symbols (symbols 1-3). In the second symbol (symbol 1) is the PBCH 404 spanning 240 subcarriers (20 RBs) and in the fourth symbol (symbol 3) is the PBCH 412 spanning 240 subcarriers (20 RBs). In the third symbol (symbol 2) is the SSS 406 spanning 127 subcarriers, a PBCH 408 spanning 4 PRBs (indexed higher than the SSS 406) and a PBCH 410 spanning 4 PRBs (indexed lower than the SSS 406).

A control resource set (CORESET) is a set of resource element groups (REG) (each REG comprising a resource block in the frequency domain and one OFDM symbol in the time domain) within which the UE attempts to blindly decode downlink control information (DCI) from the PDCCH. The CORESET may be considered a set of physical resources, e.g., a specific area on the NR downlink resource grid and a set of parameters that is used to carry PDCCH data e.g., downlink control information (DCI).

Each CORESET may have one or more search spaces (SS) defined. The PDCCH search space refers to an area in the downlink resource grid where the PDCCH may be carried. The PDCCH is transmitted on an aggregation of one or more consecutive control channel elements (CCEs), each CCE comprising multiple resource element groups (REGs), e.g., 6 REGs (72 resource elements (REs)). The number of REs of a control resource set (CORESET) used to carry a PDCCH downlink control information (DCI) message is referred to as an aggregation level (AL) and is expressed in terms of CCEs. There are currently five different PDCCH CCE ALs supported in 5G NR (ALs 1, 2, 4 8 and 16) specifying the number of CCEs used to carry the PDCCH DCI message.

The PDCCH search space includes a UE-specific search space and a common (cell-specific) search space for the UE to monitor for potential DCI formats, including, e.g., downlink (DL) grants and uplink (UL) grants. The UE-specific search space is configured for the UE via Radio Resource Control (RRC) signaling and is dedicated to the specific UE, while the common search space is targeted to all or at least a group of UEs in the cell having a RRC connection with the network/gNB. A CCE index is the CCE number at which the PDCCH is allocated. For the UE to decode the PDCCH, the UE needs to know the location of the PDCCH (CCE index), structure, scrambling code, etc.

Referring to the CBW Case-1 and CBW Case-2 described above, these narrowband operations can be restricted to a subcarrier spacing of 15 kHz and use of the normal cyclic prefix. For SSB, it is desired to reuse the PSS/SSS specification without puncturing and design the PBCH based on the current design. It is an objective to identify and specify necessary minimum changes to channels/signals including PDCCH, CSI-RS/TRS, PUCCH, and PRACH for functional support based on existing design, without optimization.

Furthermore, the following was agreed for PBCH transmission for CBW Case 1 and Case 2. For transmission bandwidths (TBW) of <5 MHz for 3 MHz and 5 MHz channel bandwidth, a subset of the PRBs of the 20-PRB PBCH are used for PBCH transmission if the TBW of a channel is less than 20 PRBs. It is open regarding which PRBs are used and how to use the PRBs.

It is assumed that, for transmission bandwidth[s] of <5 MHz, for PBCH, in the case[s] that available PRBs for PBCH transmission is less than 20 PRB, the PBCH is based on RB-level puncturing. In other words, the PBCH encoding is based on 20 PRB. The encoded bits and DMRS are mapped to 20 PRBs based on legacy SSB structure, and those PRBs that fall outside of available PRBs for PBCH transmission are punctured.

Some issues remain open for CBW Case 2 (i.e., ~3 MHz CBW). A first issue is how many PRBs and which PRBs are punctured from the legacy 20-PRB SSB structure. A second issue is how to allocate RBs for CORESET 0 and the details of Type0-CSS PDCCH Mapping. A third issue is how to indicate the CORESET 0 configuration for CBW Case 2 (i.e., ~3 MHz CBW). A fourth issue is how to prevent legacy UEs from accessing the CC with CBW Case 2?

According to various exemplary embodiments described herein, solutions are provided for the above issues regarding CBW Case-2 (~3 MHz). In one aspect, the SSB for CBW Case-2 is designed so that the PBCH fits into the narrow bandwidth. In another aspect, operations are described for indicating the CORESET #0 location on the resource grid. In still another aspect, operations are described for indicating the CORESET #0 bandwidth. In still another aspect, the allocation of RBs for the CORESET #0 (CCE-to-REG mapping) is described, including interleaved and non-interleaved mapping. In still another aspect, operations are described for configuring the CORESET #0. In still another aspect, operations are described for preventing legacy UEs from accessing the serving cell operating with less than 5 MHz spectrum.

In one aspect of these exemplary embodiments, the location of the PBCH transmission in the frequency domain (e.g., the subcarriers available for PBCH transmission) for CBW Case-2 (~3 MHz) is determined as a subset of PRBs from the 20-PRB legacy PBCH. The subset of PRBs can comprise the same number of RBs as PSS/SSS signals, i.e., 12 PRBs. Further, the UE can assume the same subcarriers as PSS/SSS are used for PBCH transmission.

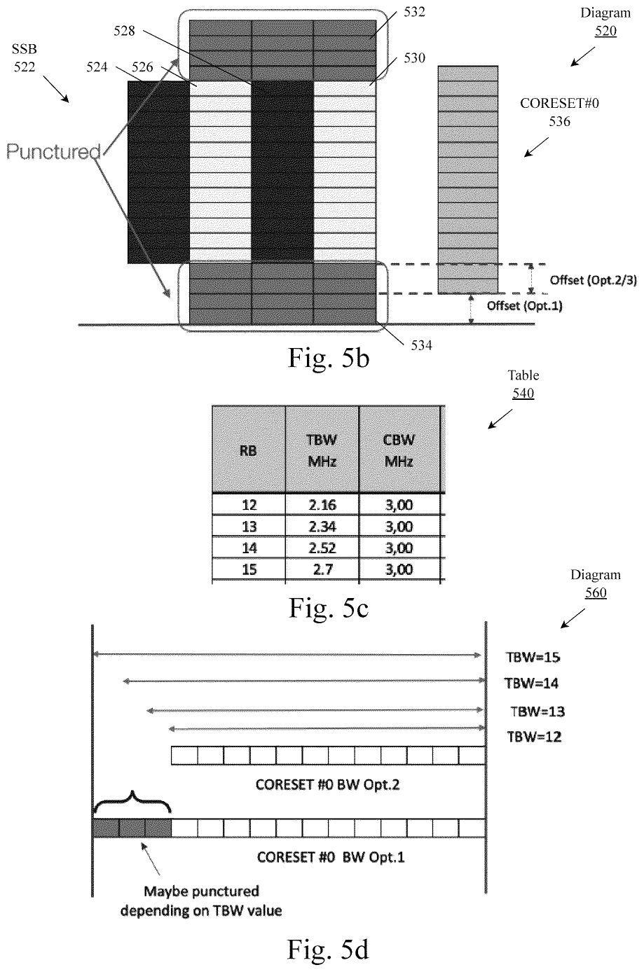

FIG. 5a shows a table 500 for the structure of an SSB including an entry for CBWs less than 5 MHz according to various exemplary embodiments. A first column 502 is for channels/signals, e.g., the PSS, the SSS, and the PBCH. A second column 504 is for the OFDM symbol number, relative to the start of the SSB, e.g., symbols 0-3. A third column 506 is for a subcarrier numbers, relative to the start of the SSB, e.g., 0-240. A fourth column 508 indicates whether a corresponding row is applicable for all CBWs, CBWs greater than or equal to 5 MHz, or CBWs less than 5 MHz.

According to the table 500, the PSS is located in OFDM symbol 0 and spans subcarriers 56-182 and the SSS is located in OFDM symbol 2 and spans subcarriers 56-182, corresponding to the existing SSB structure 400 described above for FIG. 4. This is applicable for all CBWs, including CBWs less than 5 MHz (e.g., CBW Case-2). For CBWs greater than or equal to 5 MHz, the PBCH is located in OFDM symbols 1, 2, and 3. In OFDM symbols 1 and 3, the PBCH spans subcarriers 0-235 and, in OFDM symbol 2, the PBCH spans subcarriers 0-47 and 192-239, corresponding to the existing SSB structure 400 described above for FIG. 4.

According to the present embodiments, a new entry is added to the table 500 to specify the location of the PBCH for CBWs less than 5 MHz (CBW Case-2). For this case, the PBCH is located in OFDM symbols 1 and 3 and spans subcarriers 56-182 (the same subcarriers as the PSS and SSS). The PBCH is not located in OFDM symbol 2. The SSB for CBW Case-2 is shown further below in FIG. 5b.

The PBCH indicates an offset value for the CORESET #0 so that, when the UE decodes the PBCH, the UE knows the location of the CORESET #0 in the frequency domain to search for DCI carrying SIB1.

In another aspect of these exemplary embodiments, a variety of approaches may be considered to determine the RB index of the CORESET 0 for Type0-PDCCH CSS set. The PBCH can indicate an offset that is defined from a smallest PRB index of CORESET #0 to an RB index of the SSB according to the following options.

In a first option, the offset indicated by PBCH is defined from a smallest PRB index of CORESET #0 to a smallest RB index of the corresponding SSB before puncturing. It is noted that, in this option, the smallest RB index of the SSB is a hypothetical reference point that is outside the CBW.

In a second option, the offset indicated by PBCH is defined from a smallest PRB index of CORESET #0 to a smallest RB index of the corresponding SSB after puncturing. In a third option, the offset indicated by PBCH is defined from a smallest PRB index of CORESET #0 to a first PRB of the PSS/SSS transmission. It is noted that the second and third options are functionally the same for CBW Case-2. However, the first and second options refer to a virtual RB and the third option refers to a PRB.

FIG. 5b shows a diagram 520 of the exemplary punctured PBCH transmission for a SSB according to CBW Case-2 and a CORESET #0 offset determined from the PBCH according to various exemplary embodiments. The SSB 522 spans four OFDM symbols (0-3) in the time domain and, before puncturing, 20 PRBs in the frequency domain. In the first symbol (symbol 0) is the PSS 524 spanning 12 RBs. In the second symbol (symbol 1) is the PBCH 526 spanning 12 RBs. In the third symbol (symbol 2) is the SSS 528 spanning 12 RBs. In the fourth symbol (symbol 3) is the PBCH 530 spanning 12 RBs. The PRBs outside the 12 PRBs for the PBCH and SSS in symbols 1-3, e.g., PRBs 532 and PRBs 534, are punctured.

Based on an offset value indicated in the PBCH, the starting PRB of the CORESET #0 536 can be determined. According to the first option described above, the offset is defined from the starting PRB for the SSB before puncturing. According to the second option, the offset is defined from a smallest RB index of the corresponding SSB after puncturing. According to the third option, the offset is defined from a first PRB of the PSS/SSS transmission. These offsets are shown for these three options for the CORESET #0 536.

The bandwidth of the CORESET #0 may be designed based on the possible transmission bandwidths (TBW) for the 3 MHz CBW according to the following options. The TBW refers to the actual bandwidth of the transmitted signal and is narrower than the CBW.

FIG. 5c shows a table 540 for possible TBWs for a CBW of 3 MHz (CBW Case-2) according to various exemplary embodiments. The TBW may be 12 RB, 13 RB, 14 RB or 15 RB. For 12 RBs, the TBW is 2.16 MHz. For 13 RBs, the TBW is 2.34 MHz. For 14 RBs, the TBW is 2.52 MHz. For 15 RBs, the TBW is 2.7 MHz.

In a first option, the bandwidth of CORESET #0 is equal to the maximum value of possible TBWs. Referring to the table 540, the maximum value is 15 RBs. In a second option, the bandwidth of CORESET #0 is equal to the minimum value of possible TBWs. Referring to the table 540, the minimum value is 12 RBs. When the first option is used, a sub-set of CORESET #0 RBs may be punctured when the RBs fall outside the CBW.

FIG. 5d shows a diagram 560 for the bandwidth of CORESET #0 in view of different TBWs according to various exemplary embodiments. When the first option is used and the BW of the CORESET #0 is 15 RBs, the RBs falling outside the CBW may be punctured. When the second option is used, the BW of the CORESET #0 is 12 RBs.

In another aspect of these exemplary embodiments, operations are described for implementing CCE-to-REG mapping for CORESET #0. In some embodiments, non-interleaved CCE-to-REG mapping can be used. When non-interleaved CCE-to-REG mapping is used, the modulated and precoded symbols are allocated to PRBs in a continuous and sequential manner. In other embodiments, interleaved CCE-to-REG mapping can be used. When interleaved CCE-to-REG mapping is used, the modulated and precoded symbols are allocated to the PRBs in a non-sequential and dispersed manner to increase frequency diversity.

In the following, operations for non-interleaved CCE-to-REG mapping for CORESET #0 are described. In the following, a specific example is provided in which N_{RB}=15, N_{symb}=3, where N_{symb} is the number of symbols for CORESET #0 and N_{RB} is the number of RBs of CORESET #0. However, the principles described herein can be applied to a different number of RBs (e.g., 12, 13, 14 RBs) or different number of symbols (e.g., 2 symbols). It is assumed that the REG-bundle size is fixed to be L=6. However, the principles described herein can be applied to different REG-bundle sizes. Correspondingly, in this example, R=L/N_{symb}=2 PRBs where R is the number of RBs of a REG-bundle.

In view of the above, two types of CCEs may be defined for CORESET #0. A normal CCE (CCE) comprises a full REG bundle (in one example, R=2) and a punctured CCE (pCCE) comprises a punctured REG bundle with a reduced number of RBs in frequency domain, e.g., 1 RB. Over 3 symbols, the pCCE comprises 3×1=3 RBs.

An M₁ term is defined as M₁=mod(N_{RB},L*2) and indicates whether a pCCE is in the CORESET. A K₁ term is defined as K₁=[N_{RB}/(L*2)] and indicates a number of potential PDCCH candidates, where L is the aggregation level.

$${N}_{C C E} = [ ( \frac{{N}_{R B}}{R} ) ]$$

is the number of CCEs, in one example,

$${N}_{C C E} = [ ( \frac{{N}_{R B}}{R} ) ] = [ ( 15 / 2 ) ] = 8 .$$

The CCEs m, (m=0, . . . , N_{CCE}−1) comprise REG bundle m. The CCE m,(m=0, . . . , N_{CCE}−2) are full CCEs with 2 RBs over 3 symbols. The CCE m=N_{CCE}−1 is a pCCE with 1 RB over 3 symbols.

Various approaches may be considered to determine the search space set associated with CORESET #0 for aggregation level ‘L’. In some aspects, the pCCE is not used for PDCCH transmission. With this design, only full CCEs are counted for N_{CCE} and used for PDCCH candidate determination. Defining N_{CCE} as the number of full CCEs in the search space set, N_{CCE}=[N_{RB}/R]=[15/2]=7. If M₁>0 (i.e., there is pCCE in CORESET), then the following options can be used.

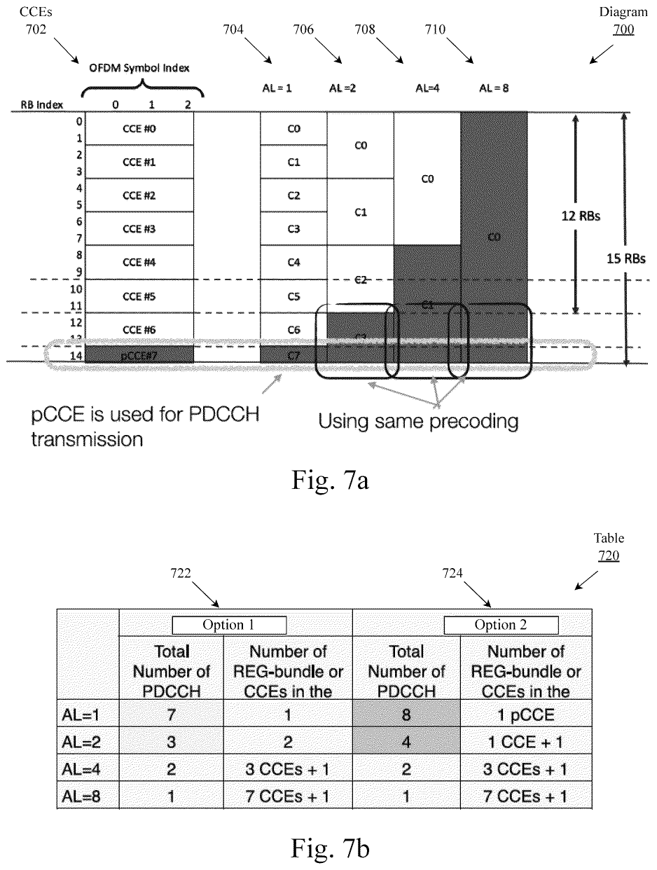

In a first option, K₁ PDCCH candidates are used for aggregation level L monitoring. K₁ represents PDCCH candidates comprising full CCEs and excludes the candidate that comprises the pCCE. The operation of the first option is described by the example of FIGS. 7a-b for N_{RB}=15 and R=2. However, it should be understood that different numbers of resource blocks, symbols, etc. can be used and these numbers may vary, e.g., NRB may be 12, 13, 14.

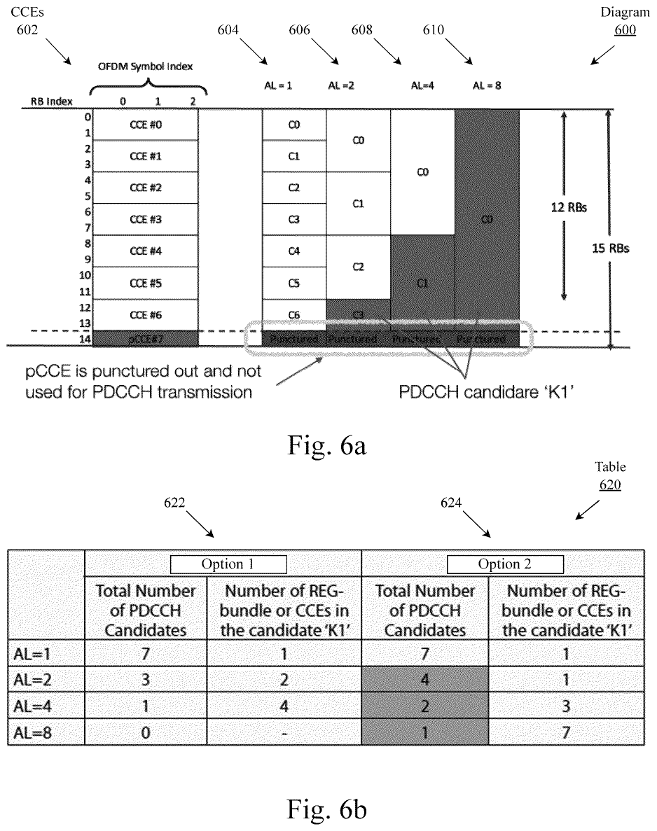

FIG. 6a shows a diagram 600 for CCE-to-REG mapping when a punctured CCE (pCCE) is not used for PDCCH transmission according to various examples of these exemplary embodiments. In this example, N_{RB}=15 and R=2. The number of CCEs N_{CCE} refers to a number of full CCEs. Thus, N_{CCE}=7 (CCE #s 0-6), as shown in 602. The punctured CCE (pCCE #7) is not counted.

The AL (L) can be 1, 2, 4, or 8. FIG. 6b shows a table 620 referring to the diagram 600 of FIG. 6a and summarizing the total number of PDCCH candidates and the number of CCEs in candidate K₁ per aggregation level (AL).

For L=1, in 604, the number of PDCCH candidates K₁ is 7 (CO-C6). Thus, each PDCCH candidate (including K₁ (C6)) comprises one CCE (full CCE). The potential candidate C7 (1 REG) comprising the pCCE is not used. For L=2, in 606, the number of PDCCH candidates K₁ is [7/2]=3 (CO-C2). Thus, each PDCCH candidate (including K₁ (C2)) comprises two CCEs. The potential candidate C3 (3 REG) comprising the pCCE is not used. For L=4, in 608, the number of PDCCH candidates K₁ is [7/4]=1 (CO). Thus, the PDCCH candidate K₁ (CO) comprises four CCEs. The potential candidate C1 (7 REG) comprising the pCCE is not used. For L=8, in 610, there are no PDCCH candidates (K1 is [7/8]=0). The potential candidate CO (15 REG) comprising the pCCE is not used.

Thus, for the first option, as shown on the left side 622 of the table 620, for AL=1, there are 7 PDCCH candidates each comprising 1 CCE; for AL=2, there are 3 PDCCH candidates each comprising 2 CCEs; for AL=4, there is one PDCCH candidate comprising 4 CCEs; AL=8 is not supported.

In the second option, the candidate that comprises the pCCE is counted in the PDCCH candidates and RB-bundled based puncturing is used wherein the PDCCH candidate i,i=0, . . . , K₁−1 comprises L full CCEs while PDCCH candidate K₁ comprises L−1 full CCEs. Thus, only the pCCE is excluded from PDCCH transmission.

Referring to the diagram 600, for the second option, the number of CCEs N_{CCE} refers to a number of all CCEs including full and punctured. Thus, N_{CCE}=8 (CCE #s 0-6, pCCE #7). The AL (L) can be 1, 2, 4, or 8. The number of PDCCH candidates, and the size of each, will vary based on AL.

For L=1, in 604, the number of PDCCH candidates K₁ is 7 (CO-C6). The potential candidate C7 comprising the pCCE does not comprise any full CCEs and is not used. Thus, each PDCCH candidate (including K₁ (C6)) comprises one CCE (full CCE). For L=2, in 606, the number of PDCCH candidates K₁ is [7/2]=4 (CO-C3). The pCCE is part of C3 but is punctured out. Thus, the full PDCCH candidates (CO-C2) comprise two full CCEs and K₁=4 (C3) comprises 2−1=1 full CCE. For L=4, in 608, the number of PDCCH candidates K₁ is [7/4]=2 (CO-C1). The pCCE is part of C1 but is punctured out. Thus, the full PDCCH candidate (CO) comprises 4 full CCEs and PDCCH candidate C1 comprises 4−1=3 three full CCEs. For L=8, in 610, the number of PDCCH candidates K₁ is [7/8]=1 (CO). The pCCE is part of CO but is punctured out. Thus, the PDCCH candidate CO comprises 8−1=7 full CCEs.

Thus, for the second option, as shown on the right side 624 of the table 620, for AL=1, there are 7 total PDCCH candidates CO-C6, all of which are full PDCCH candidates each comprising 1 full CCE; for AL=2, there are 4 total PDCCH candidates CO-C3, three of which are full PDCCH candidates comprising 2 full CCEs and one of which is a partial PDCCH candidate comprising 1 full CCE; for AL=4, there are 2 total PDCCH candidates CO-C1, one of which is a full PDCCH candidate comprising 4 full CCEs and one of which is a partial PDCCH candidate comprising 3 full CCEs; for AL=8, there is 1 total PDCCH candidate that is a partial PDCCH candidate comprising 7 full CCEs.

In another aspect of these exemplary embodiments, the pCCE is used for PDCCH transmission to maximize the available RBs for PDCCH transmission. If M₁>0, for aggregation level L monitoring, the PDCCH candidate i,i=0, . . . , K₁−1 consists of L full CCEs while PDCCH candidate K₁ consists of L−1 full CCEs and a single pCCE.

FIG. 7a shows a diagram 700 for CCE-to-REG mapping when a punctured CCE (pCCE) is used for PDCCH transmission according to various examples of these exemplary embodiments. In this example, N_{RB}=15 and R=2. The number of CCEs N_{CCE} refers to a total number of CCEs including the pCCE. Thus, N_{CCE}=8 (CCE #s 0-6, pCCE #7), as shown in 702.

The AL (L) can be 1, 2, 4, or 8. FIG. 7b shows a table 720 referring to the diagram 700 of FIG. 7a and summarizing the total number of PDCCH candidates and the number of CCEs in candidate K₁ per aggregation level (AL).

For L=1, in 704, the number of PDCCH candidates K₁ is 8 (CO-C7). The candidate C7 comprises the pCCE only. Thus, PDCCH candidates CO-C6 comprise one full CCE and K₁ (C6) comprises one pCCE. For L=2, in 706, the number of PDCCH candidates K₁ is [7/2]=4 (CO-C3). The pCCE is part of C3. Thus, the full PDCCH candidates (CO-C2) comprise two full CCEs and K₁=4 (C3) comprises 1 full CCE and 1 pCCE. For L=4, in 708, the number of PDCCH candidates K₁ is [7/4]=2 (CO-C1). The pCCE is part of C1. Thus, the full PDCCH candidate (C0) comprises 4 full CCEs and PDCCH candidate C1 comprises three full CCEs and 1 pCCE. For L=8, in 710, the number of PDCCH candidates K₁ is [7/8]=1 (CO). The pCCE is part of CO. Thus, the PDCCH candidate CO comprises 7 full CCEs and one pCCE.

In one option, the pCCE may be only used for larger Aggregation Levels (ALs) that has a smaller number of PDCCH candidates in CORESET #0, e.g., AL4 and AL8. For smaller ALs with a larger number of PDCCH candidates, e.g., AL1 and AL2, the pCCE may be punctured out, similar to the first option above. In another option, the pCCE may be used for all Als, with some preconditions being applied for this option to be described below.

For the second option, when the pCCE is used for PDCCH transmission for all Als, as shown on the right side 724 of the table 720, for AL=1, there are 8 total PDCCH candidates CO-C7, 7 of which are full PDCCH candidates each comprising 1 full CCE and one of which is a pCCE; for AL=2, there are 4 total PDCCH candidates CO-C3, three of which are full PDCCH candidates comprising 2 full CCEs and one of which is a partial PDCCH candidate comprising 1 full CCE and 1 pCCE; for AL=4, there are 2 total PDCCH candidates CO-C1, one of which is a full PDCCH candidate comprising 4 full CCEs and one of which is a partial PDCCH candidate comprising 3 full CCEs and 1 pCCE; for AL=8, there is 1 total PDCCH candidate that is a partial PDCCH candidate comprising 7 full CCEs and 1 pCCE.

For the first option, when the pCCE is used for PDCCH transmission for larger Als (4, 8), as shown on the left side 722 of the table 720, for AL=1, there are 7 total PDCCH candidates CO-C6, all of which are full PDCCH candidates each comprising 1 full CCE; for AL=2, there are 4 total PDCCH candidates CO-C3, three of which are full PDCCH candidates comprising 2 full CCEs and one of which is a partial PDCCH candidate comprising 1 full CCE; for AL=4, there are 2 total PDCCH candidates CO-C1, one of which is a full PDCCH candidate comprising 4 full CCEs and one of which is a partial PDCCH candidate comprising 3 full CCEs and 1 pCCE; for AL=8, there is 1 total PDCCH candidate that is a partial PDCCH candidate comprising 7 full CCEs and 1 pCCE.

If the second option is used, to ensure the channel estimation and decoding performance for AL2, the following one or more conditions need to be fulfilled. In one option, the higher-layer parameter ‘precoderGranularity’ is set as ‘allContiguousRBs’, (i.e., wideband precoding). In another option, the UE always assumes the same precoding being used within a PDCCH candidate. In still another option, the UE always assumes a same precoding being used for the pCCE and the consecutive CCE.

In some aspects of these exemplary embodiments, enhanced interleaved CCE-to-REG mapping can be used. For CORESET #0, the following configuration may be hard-encoded in specification for CCE-to-REG mapping: N_{RB}=15, N_{symb}=3, R=2, N_{CCE}=N_{RB}/R=15/2=8. The pREG-Bundle is counted as ‘a normal CCE’ and used for PDCCH monitoring.

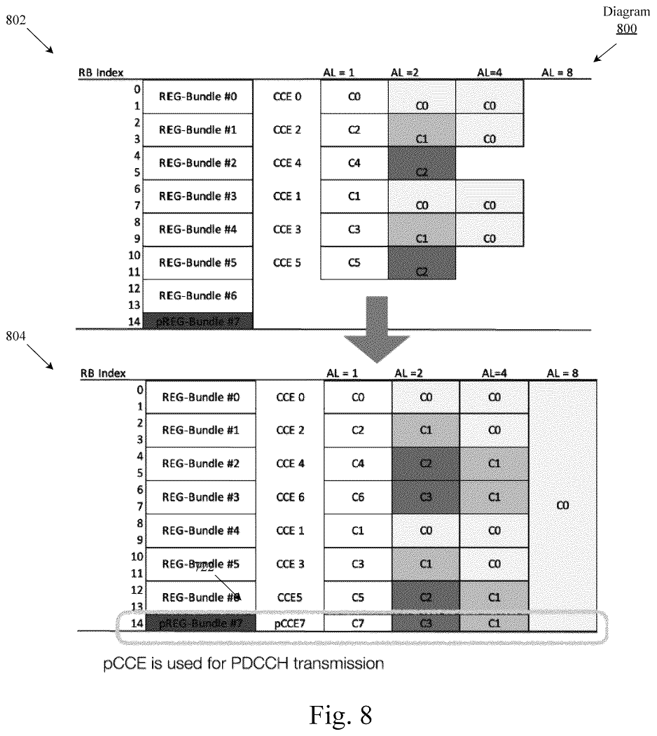

FIG. 8 shows a diagram 800 including the PDCCH candidate(s) 802 without counting the pREG-Bundle #7 (i.e., Rel-17 mapping) and an enhanced interleaved PDCCH search space set 804 according to various exemplary embodiments. In the legacy mapping of 802, only 6 CCEs are used for PDCCH transmission when AL=1 (6 PDDCH candidates) or AL=2 (3 PDCCH candidates), and only 4 CCEs are used for PDCCH transmission when AL=4 (1 PDCCH candidate). AL=8 is not supported.

In the interleaved PDCCH SS 804, 8 CCEs (including the pCCE) are used for PDCCH transmission for all Als, e.g., 8 PDCCH candidates for AL=1; 4 PDCCH candidates for AL=2; 2 PDCCH candidates for AL=3; and 1 PDCCH candidate for AL=8. With counting the ‘pREG-Bundle’ as part of search space set, the following is enhanced: AL=8 is supported; one more candidate is supported for AL2 and AL4; two more candidates are supported for AL1.

In another aspect of the present disclosure, a variety of approaches may be considered to indicate the configuration of CORESET 0 for NR<5 MHz Spectrum. In a first option, a new configuration is indicated by repurposing the ‘reserved’ row #15 so that index 15 configures the number of PRBs and the number of symbols for the CORESET for less than 5 MHz. The configuration can be hard-encoded in specification with the follow setting: 15 or 16 PRBs; 2 or 3 symbols.

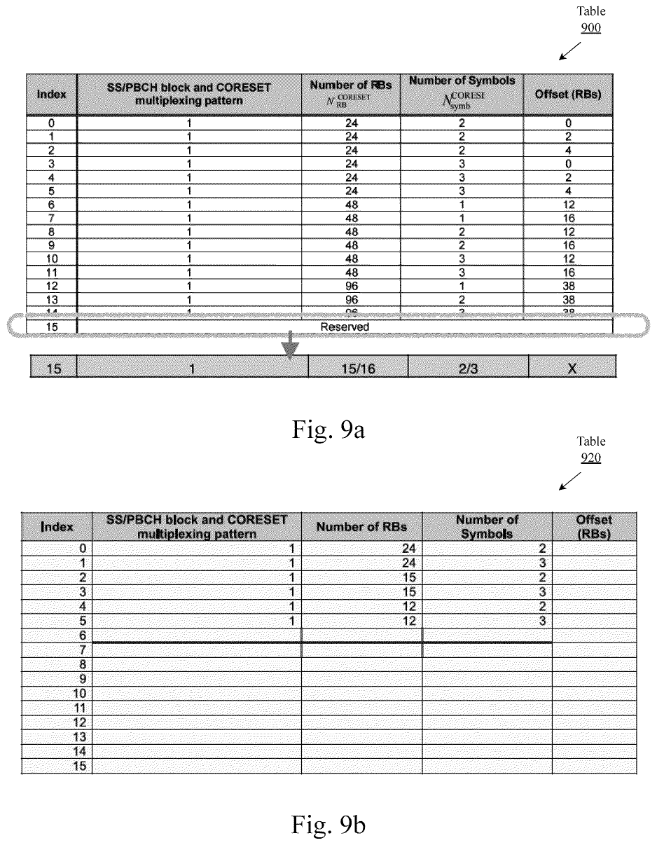

FIG. 9a shows a table 900 for indicating the configuration of CORESET #0 for CBW under 5 MHz by repurposing an existing field according to various exemplary embodiments. The index 15 can indicate a number of RBs for the CORESET #0, a number of symbols for the CORESET #0, and an offset for the CORESET #0. For operations under 5 MHz CBW, the number of RBs can be, e.g., 15 or 16 and the number of symbols can be, e.g., 2 or 3. The offset was discussed previously.

In a second option, a new table may be introduced, which is dedicated for NR<5 MHz spectrum. This provides more flexibility for CORESET 0 configuration with supporting more than one rows. In some designs, the new table may include CORESET configurations for both CBW Case-1 and CBW Case 2. Further, different numbers of PRBs and symbols can be mapped to an index.

FIG. 9b shows a new table 920 for indicating the configuration of CORESET #0 for CBW less than or equal to 5 MHz according to various exemplary embodiments. Various entries can be made corresponding to a CORESET #0 that can be used for CBW less than or equal to 5 MHz. Various indices can indicate, e.g., a number of RBs equal to 24, 15 or 12; a number of symbols equal to 2 or 3; and an offset as discussed previously.

According to certain aspects of this disclosure, a variety of approach may be considered to prevent legacy UEs accessing the serving cell with <5 MHz Spectrum.

In a first option, a new synchronization raster maybe specified for the bands operating with <5 MHz Spectrum e.g., with different sync raster step size. In some designs, one or more synchronization rasters may be hard-encoded in specification for these bands.

In a second option, a default value k_{SSB}=0 may be defined for these bands operating with <5 MHz Spectrum for a given CC. In addition, k_{SSB}=30 is indicated by MIB payload on PBCH to prevent legacy UE from accessing this CC.

In a third option, the reserved bit in MIB payload is repurposed to indicate whether Rel-18 UE is barred for the accessing cell or not. With this design, the NW can set 1-bit ‘cellBarred’=1 to bar the legacy UE for cell accessing (e.g., enabled).

In a fourth option, a default value 15 kHz SCS is assumed for Rel-18 UE for these bands. Accordingly, NW can set 1-bit ‘SCScommon’ to be ‘1’ (i.e., 30 kHz SCS for SIB1, Msg2/4), which would result in access failure of legacy UE. This option is not preferred from UE perspective as it results in excess power consumption.

In a fifth option, for FR1, a₆, a₇ are reserved in PBCH payload. One of these two bits may be repurposed to indicate whether Rel-18 device is barred for the accessing cell or not.

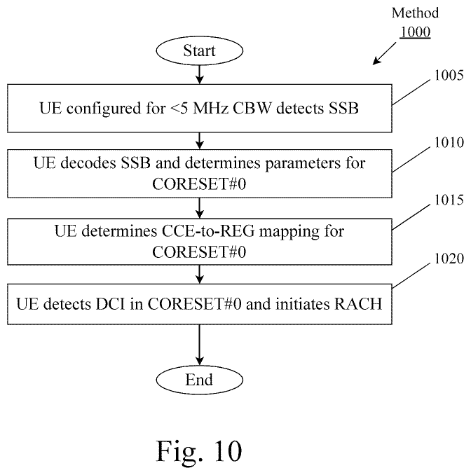

FIG. 10 shows a method 1000 for initial access for spectrum less than 5 MHz according to various exemplary embodiments.

In 1005, a UE configured for <5 MHz operation detects a SSB. The UE assumes the PBCH is punctured when decoding the PBCH.

In 1010, the UE decodes the SSB and determines the CORESET #0 configuration (indicating NRB, number of symbols, offset); determines the location of the CORESET #0 (smallest PRB index) based on the offset value; and determines the BW of the CORESET.

In 1015, the UE determines the CCE to REG mapping for the CORESET #0. According to the various options discussed above, the mapping can exclude or include the pCCE, can be non-interleaved or interleaved, etc.

In 1020, the UE detects DCI in the CORESET #0 and initiates RACH.

### EXAMPLES

In a first example, a method is performed by a processor of a user equipment (UE) configured for operations with a serving cell in spectrum allocations less than 5 MHz, the method comprising detecting a synchronization signal block (SSB) including a primary synchronization signal (PSS) spanning a number of subcarriers, a secondary synchronization signal (SSS) spanning the number of subcarriers, and a physical broadcast channel (PBCH) that is considered to comprise a same number of subcarriers as the PSS and SSS, decoding the PBCH and determining, from the PBCH, a configuration, a location and a bandwidth in a frequency domain for a control resource set 0 (CORESET #0) defining resources associated with a common search space (CSS) for a physical downlink control channel (PDCCH) monitoring.

In a second example, the method of the first example, wherein the UE considers a legacy PBCH comprising 20 physical resource blocks (PRB) is punctured in the frequency domain to match the number of PRBs of the PSS and SSS, wherein the number of PRBs of the PSS and SSS is 12 PRBs.

In a third example, the method of the second example, wherein determining the location of the CORESET #0 comprises determining a PRB index of the CORESET #0 based on an offset value indicated by the PBCH.

In a fourth example, the method of the third example, wherein the offset value is defined from a smallest PRB index of the CORESET #0 to a smallest PRB index of the SSB before puncturing.

In a fifth example, the method of the third example, wherein the offset value is defined from a smallest PRB index of the CORESET #0 to a smallest PRB index of the SSB after puncturing.

In a sixth example, the method of the third example, wherein the offset value is defined from a smallest PRB index of the CORESET #0 to a first PRB of the PSS and SSS.

In a seventh example, the method of the first example, wherein the bandwidth of the CORESET #0 is defined based on possible transmission bandwidths (TBW) in spectrum allocations less than 5 MHz, the possible TBWs corresponding to 12, 13, 14 or 15 PRBs.

In an eighth example, the method of the seventh example, wherein the bandwidth of the CORESET #0 is equal to a maximum value of the possible TBWs that is equal to 15 PRBs.

In a ninth example, the method of the seventh example, wherein the bandwidth of the CORESET #0 is equal to a minimum value of the possible TBWs that is equal to 12 PRBs.

In a tenth example, the method of the first example, wherein the configuration of the CORESET #0 is indicated as an index value corresponding to a row of a table providing a number of resource blocks (RBs), a number of symbols, and an offset.

In an eleventh example, the method of the tenth example, wherein the table is a legacy table and the index value is 15.

In a twelfth example, the method of the tenth example, wherein the table is a new table for spectrum allocations less than 5 MHz, the new table comprising a number of rows with different combinations of the number of RBs and the number of symbols.

In a thirteenth example, the method of the twelfth example, wherein the new table is also for spectrum allocations equal to 5 MHz.

In a fourteenth example, the method of the first example, wherein the SSB is detected using a synchronization raster specified for bands less than 5 MHz.

In a fifteenth example, a processor of a user equipment (UE) configured to perform any of the methods of the first through fourteenth examples.

In a sixteenth example, a user equipment (UE) comprising a transceiver configured to communicate with a network and a processor communicatively coupled to the transceiver and configured to perform any of the methods of the first through fourteenth examples.

In a seventeenth example, a method is performed by a user equipment (UE) configured for operations with a serving cell in spectrum allocations less than 5 MHz, the method comprising detecting a synchronization signal block (SSB) including a primary synchronization signal (PSS), a secondary synchronization signal (SSS), and a physical broadcast channel (PBCH), decoding the PBCH, determining a number of resource blocks (RB) in a resource element group (REG) bundle for a CORESET #0 that is predefined for the spectrum allocations less than 5 MHz, determining a number of control channel elements (CCEs) and whether a punctured CCE (pCCE) is present in the CORESET #0 and determining a number of physical downlink control channel (PDCCH) candidates to monitor in a common search space associated with the CORESET #0 based on whether a PDCCH candidate comprising the pCCE is to be monitored.

In an eighteenth example, the method of the seventeenth example, wherein the pCCE in the CORESET #0 is not monitored for a PDCCH candidate transmission.

In a nineteenth example, the method of the eighteenth example, wherein each of the PDCCH candidates to be monitored comprise full CCEs in the CORESET #0.

In a twentieth example, the method of the nineteenth example, wherein the CCEs are mapped to REGs in a non-interleaved manner for CORESET #0.

In a twenty first example, the method of the eighteenth example, wherein the PDCCH candidate comprising the pCCE is monitored with the pCCE punctured out.

In a twenty second example, the method of the twenty first example, wherein the PDCCH candidate comprising the pCCE comprises L−1 full CCEs, wherein L is an aggregation level of the PDCCH candidate that is configured by higher layers.

In a twenty third example, the method of the twenty first example, wherein the CCEs are mapped to REGs in a non-interleaved manner.

In a twenty fourth example, the method of the seventeenth example, wherein the pCCE is monitored for a PDCCH candidate transmission.

In a twenty fifth example, the method of the twenty fourth example, wherein the PDCCH candidates to be monitored comprise a candidate with the pCCE.

In a twenty sixth example, the method of the twenty fifth example, wherein the CCEs are mapped to REGs in a non-interleaved manner for the CORESET #0.

In a twenty seventh example, the method of the twenty sixth example, wherein the pCCE is monitored only for aggregation levels greater than 2.

In a twenty eighth example, the method of the twenty sixth example, wherein the pCCE is monitored for aggregation levels 1 and 2 when one or more conditions are met.

In a twenty ninth example, the method of the twenty eighth example, wherein the one or more conditions comprise a higher layer parameter precoderGranularity is set as allContiguousRBs.

In a thirtieth example, the method of the twenty eighth example, wherein the one or more conditions the UE assumes a same precoding is used for the PDCCH candidates.

In a thirty first example, the method of the twenty eighth example, wherein the one or more conditions the UE assumes a same precoding is used for the PDCCH candidate comprising the pCCE and a preceding CCE.

In a thirty second example, the method of the twenty fourth example, wherein the CCEs and the pCCE are mapped to REGs in an interleaved manner for the CORESET #0.

In a thirty third example, the method of the thirty second example, wherein the pCCE is counted as a normal CCE to perform an interleaved CCE-to-REG mapping.

In a thirty fourth example, a processor of a user equipment (UE) configured to perform any of the methods of the seventeenth through thirty third examples.

In a thirty fifth example, a user equipment (UE) comprising a transceiver configured to communicate with a network and a processor communicatively coupled to the transceiver and configured to perform any of the methods of the seventeenth through thirty third examples.

In a thirty sixth example, a method is performed by a base station configured for operations with a first user equipment (UE) in spectrum allocations less than 5 MHz, the method comprising transmitting a synchronization signal block (SSB) including a primary synchronization signal (PSS), a secondary synchronization signal (SSS), and a physical broadcast channel (PBCH), wherein the PBCH comprises a same number of subcarriers as the PSS and SSS, wherein the PBCH indicates a configuration, a location and a bandwidth in a frequency domain for a control resource set 0 (CORESET #0) defining resources associated with a common search space (CSS) for monitoring a physical downlink control channel (PDCCH) and transmitting one PDCCH within one or more PDCCH candidates in the CORESET #0, wherein the one or more PDCCH candidates are determined based on whether a punctured control channel element (pCCE) is to be monitored by the first UE.

In a thirty seventh example, the method of the thirty sixth example, further comprising preventing a second UE from accessing the base station operating with spectrum allocations less than 5 MHz.

In a thirty eighth example, the method of the thirty seventh example, wherein the PBCH indicates a k_{SSB} value in a master information block (MIB) that, when read by the second UE, prevents the second UE from accessing a component carrier.

In a thirty ninth example, the method of the thirty seventh example, wherein the PBCH indicates a bit repurposed from a reserved bit in a master information block (MIB) and the repurposed bit is read by the first UE, indicates whether the first UE is barred from accessing the base station and a ‘cellBarred’ field in the MIB is set to be ‘enabled’, which is read by the second UE and prevents it from accessing the base station and the ‘cellBarred’ field in the MIB is omitted by the first UE.

In a fortieth example, the method of the thirty seventh example, further comprising setting a 1 bit SCSCommon field in a master information block (MIB) to a value of 1 when a 15 kHz subcarrier spacing is used by the base station so that the second UE would fail in accessing the base station.

In a forty first example, the method of the thirty seventh example, wherein the PBCH comprises a bit that is repurposed from a reserved a₆ or a₇ bit in the PBCH that, when read by the first UE, indicates whether the first UE is barred from accessing the base station and a ‘cellBarred’ field in a Master Information Block (MIB) message is set to be ‘enabled’, which is read by the second UE and prevent it from accessing the base station and the ‘cellBarred’ field in the MIB is omitted by the first UE.

In a forty second example, a processor of a base station configured to perform any of the methods of the thirty sixth through forty first examples.

In a forty third example, a base station comprising a transceiver configured to communicate with a user equipment (UE) and a processor communicatively coupled to the transceiver and configured to perform any of the methods of the thirty sixth through forty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured for operations with a serving cell in spectrum allocations less than 5 MHz configured to perform operations comprising:
detecting a synchronization signal block (SSB) including a primary synchronization signal (PSS) spanning a number of subcarriers, a secondary synchronization signal (SSS) spanning the number of subcarriers, and a physical broadcast channel (PBCH) that is considered to comprise a same number of subcarriers as the PSS and SSS;
decoding the PBCH; and
determining, from the PBCH, a configuration, a location and a bandwidth in a frequency domain for a control resource set 0 (CORESET #0) defining resources associated with a common search space (CSS) for a physical downlink control channel (PDCCH) monitoring.

2. The processor of claim 1, wherein the UE considers a legacy PBCH comprising 20 physical resource blocks (PRB) is punctured in the frequency domain to match the number of PRBs of the PSS and SSS, wherein the number of PRBs of the PSS and SSS is 12 PRBs.

3. The processor of claim 2, wherein determining the location of the CORESET #0 comprises determining a PRB index of the CORESET #0 based on an offset value indicated by the PBCH.

4. The processor of claim 3, wherein the offset value is defined from a smallest PRB index of the CORESET #0 to a smallest PRB index of the SSB before puncturing.

5. The processor of claim 3, wherein the offset value is defined from a smallest PRB index of the CORESET #0 to a smallest PRB index of the SSB after puncturing.

6. The processor of claim 3, wherein the offset value is defined from a smallest PRB index of the CORESET #0 to a first PRB of the PSS and SSS.

7. The processor of claim 1, wherein the bandwidth of the CORESET #0 is defined based on possible transmission bandwidths (TBW) in spectrum allocations less than 5 MHz, the possible TBWs corresponding to 12, 13, 14 or 15 PRBs.

8. The processor of claim 7, wherein the bandwidth of the CORESET #0 is equal to a maximum value of the possible TBWs that is equal to 15 PRBs.

9. The processor of claim 7, wherein the bandwidth of the CORESET #0 is equal to a minimum value of the possible TBWs that is equal to 12 PRBs.

10. The processor of claim 1, wherein the configuration of the CORESET #0 is indicated as an index value corresponding to a row of a table providing a number of resource blocks (RBs), a number of symbols, and an offset.

11. The processor of claim 10, wherein the table is a legacy table and the index value is 15.

12. The processor of claim 10, wherein the table is a new table for spectrum allocations less than 5 MHz, the new table comprising a number of rows with different combinations of the number of RBs and the number of symbols.

13. The processor of claim 12, wherein the new table is also for spectrum allocations equal to 5 MHz.

14. The processor of claim 1, wherein the SSB is detected using a synchronization raster specified for bands less than 5 MHz.

15. A processor of a base station configured for operations with a first user equipment (UE) in spectrum allocations less than 5 MHz configured to perform operations comprising:
transmitting a synchronization signal block (SSB) including a primary synchronization signal (PSS), a secondary synchronization signal (SSS), and a physical broadcast channel (PBCH), wherein the PBCH comprises a same number of subcarriers as the PSS and SSS, wherein the PBCH indicates a configuration, a location and a bandwidth in a frequency domain for a control resource set 0 (CORESET #0) defining resources associated with a common search space (CSS) for monitoring a physical downlink control channel (PDCCH); and
transmitting one PDCCH within one or more PDCCH candidates in the CORESET #0, wherein the one or more PDCCH candidates are determined based on whether a punctured control channel element (pCCE) is to be monitored by the first UE.

16. The base station of claim 15, wherein the operations further comprise:
preventing a second UE from accessing the base station operating with spectrum allocations less than 5 MHz.

17. The base station of claim 16, wherein the PBCH indicates a k_{SSB} value in a master information block (MIB) that, when read by the second UE, prevents the second UE from accessing a component carrier.

18. The base station of claim 16, wherein the PBCH indicates a bit repurposed from a reserved bit in a master information block (MIB); and
the repurposed bit is read by the first UE, indicates whether the first UE is barred from accessing the base station; and
a ‘cellBarred’ field in the MIB is set to be ‘enabled’, which is read by the second UE and prevents it from accessing the base station; and
the ‘cellBarred’ field in the MIB is omitted by the first UE.

19. The base station of claim 16, wherein the operations further comprise:
setting a 1 bit SCSCommon field in a master information block (MIB) to a value of 1 when a 15 kHz subcarrier spacing is used by the base station so that the second UE would fail in accessing the base station.

20. The base station of claim 16, wherein the PBCH comprises a bit that is repurposed from a reserved a₆ or a₇ bit in the PBCH that,
when read by the first UE, indicates whether the first UE is barred from accessing the base station; and
a ‘cellBarred’ field in a Master Information Block (MIB) message is set to be ‘enabled’, which is read by the second UE and prevent it from accessing the base station; and
the ‘cellBarred’ field in the MIB is omitted by the first UE.
